(19) United States
(12) Patent Application Publication
(10) Pub. No.: US 2009/0035208 A1
(43) Pub. Date: Feb. 5, 2009

(54) Nanoporous Catalyst Particles, the Production Thereof and Their Use

(76) Inventors: Peter Axmann, Erbach (DE); Margret Wohlfahrt-Mehrens, Illertissen (DE); Michael Kasper, Illertissen (DE); Wolfgang Weirather, Dornstadt (DE)

Correspondence Address: THE NATH LAW GROUP, 112 South West Street, Alexandria, VA, 22314, US

(21) Appl. No.: 11/922,775

(22) PCT Filed: Jul. 7, 2006
(86) PCT No.: PCT/EP2006/006681

§ 371 Date: Jun. 12, 2008

(30) Foreign Application Priority Data
Jul. 8, 2005 (DE) 102005032071.6

(51) Int. Cl. B01J 21/18; B01J 23/32; B01J 23/755; C04B 35/00; D01F 9/12; B01J 23/75; B01J 23/745

(52) U.S. Cl. 423/447.1; 502/324; 502/337; 502/338; 502/325; 502/174; 501/1

(57) ABSTRACT

The invention relates to nanoporous catalyst particles having a spherical and/or spheroidal secondary structure, which contain, as catalytically active constituents, transition metals and/or oxides or precursors thereof. The invention also relates to a method for producing the nanoporous catalyst particles, during which, by means of a precipitation process, precursors with a spherical and/or spheroidal preliminary shape are produced from soluble compounds of the active constituents, and these morphologically pre-shaped precursors are, in a thermal activation step, transformed into nanoporous catalyst particles having a spherical and/or spheroidal secondary structure. The inventive catalyst particles can be used in the production of ceramic materials, as electrode materials in electrochemical cells or in fuel cells, as storage materials for chemical species and, in particular, in the production of carbon nanoparticles in the form of small tubes or fibers.

### FIELD OF THE INVENTION

The present invention relates to nanoporous catalyst particles with a spherical and/or spheroidal secondary structure, the production thereof, and their use, particularly in the manufacture of carbon nanoparticles in the form of tubes or fibers.

### PRIOR ART

Supported catalyst particles with active components in the nanoscale range are known. Catalyst/support systems based on Ni/Al₂O₃ can be produced, for example, through saturation of Al₂O₃ precursors with nickel salt solutions and subsequent reduction or decomposition of nickel-containing aluminum hydroxides or oxides and reduction of the nickel.

It is possible to shape such systems by means of spray agglomeration. As a rule, however, units produced in this way are not as stable as grown structures. Frequently, the use of binding agents is required. In addition, it is not as a rule possible to control the pore structure in the grain.

A fundamental difficulty in such catalyst/support systems, therefore, is the low controllability of microporosity and nanoporosity within the individual particles in combination with the size of the catalytically active components and the process technology-relevant external morphological properties such as particle size and particle shape.

### OBJECT OF THE INVENTION

The object of the present invention, therefore, is to provide stable catalyst particles with controllable microporosity and nanoporosity and a method for their manufacture.

### SUMMARY OF THE INVENTION

The above-mentioned object is attained by means of the nanoporous catalyst particles recited in claim 1 and by means of a method for their manufacture recited in claim 6.

Preferred and suitable embodiments of the subject of the application are disclosed in the dependent claims. Possible uses of the nanoporous catalyst particles according to the present invention are disclosed in claims 10-13.

The subject of the present invention consequently includes nanoporous catalyst particles with a spherical and/or spheroidal secondary structure, which contain, as catalytically active components, transitional metals and/or their oxides or their precursors.

Another subject of the present invention is a method for manufacturing nanoporous catalyst particles in which, by means of a precipitation process, precursors with a spherical and/or spheroidal preliminary shape are produced from soluble combinations of the active components and in a thermal activation step, these morphologically pre-shaped precursors are transformed into the nanoporous catalyst particles with a spherical and/or spheroidal secondary structure.

Lastly, another subject of the invention is the use of nanoporous catalyst particles in the manufacture of ceramic materials, as electrode materials in electrochemical cells or fuel cells, as storage materials (adsorbents) for chemical species, and particularly in the manufacture of carbon nanoparticles in the form of tubes or fibers.

### DETAILED DESCRIPTION OF THE INVENTION

The catalyst particles according to the present invention differ from conventional catalyst structures in that they are embodied as structural units of definite internal morphology. Through selective morphological preshaping of the catalysts by means of the precursor morphology combined with an activation step, it is possible to obtain nanoporous catalyst particles in which the nanoporosity of the grain is controllable. In the activation of catalyst precursors with a spherical and/or spheroidal preliminary shape, nanocrystalline metals and/or metal oxides are generated with a simultaneous production of nanoporosity and the catalyst particles form a spherical and/or spheroidal secondary structure.

According to the present invention, it has been discovered that controlling the precursor growth structure makes it possible to preshape the pore structure for the actual catalyst grain.

The catalyst particles according to the present invention contain, as active components, transitional metals and/or their oxides or their precursors; in particular, Fe, Co, Ni, and Mn are preferred for the transitional metals. These catalyst particles can contain additional metal oxides such as alkaline earth metal oxides or aluminum oxides or their precursors, which serve as a substrate for the actual catalytically active metals. Both the pure metals and metal oxides/metal composites can be used. In particular, suitable precursors include poorly soluble compounds such as hydroxides, carbonates, or other compounds that can be transformed into catalytically active metals or metal/support composites.

The spherical and/or spheroidal secondary structures preferably have a diameter of 0.5-100 μm.

The manufacture of the catalyst particles according to the present invention is carried out in that, by means of a precipitation process, precursors with a spherical and/or spheroidal preliminary shape are produced from soluble combinations of the active components and in a thermal activation step, these morphologically pre-shaped precursors are transformed into the nanoporous catalyst particles with a spherical and/or spheroidal secondary structure. The precipitation process is preferably carried out in the neutral to alkaline range, preferably with pH values of 7-13 and at temperatures of 10-80° C. in an aqueous medium. In this connection, the manufacture of precursors with a spherical and/or spheroidal preliminary shape is controlled through suitable control of the pH value, the temperature, and the agitation speed.

The activation step can be carried out in an oxidative or reductive atmosphere, preferably in a reductive atmosphere at temperatures in the range from 300-1000° C.

In addition, the activation step can be carried out ex situ or in situ during the technical use of the catalyst particles.

The catalyst particles according to the present invention can be used in a variety of application fields, for example in the manufacture of ceramic materials, as electrode materials in electrochemical cells or fuel cells, or as storage materials (adsorbents) for chemical species, for example as carbonate storage.

The preferred use of the nanopbrous catalyst particles according to the present invention, however, is in the manufacture of carbon nanoparticles in the form of tubes or fibers. Specifically, it has turned out that the catalyst particles according to the present invention permit the manufacture of carbon nanoparticles that are morphologically embodied in the form of macroscopic spherical and/or spheroidal secondary agglomerates that are clearly differentiated from one another. In this instance, it has been discovered that the form of the secondary agglomerates almost completely reproduces that of the particle form of the catalyst particles according to the present invention; in comparison to the catalyst particles used, a volume increase is observed, which, depending on the reaction conditions, can exceed the initial structure by a factor of approximately 350.

Due to the clear definition of the secondary agglomerates and the possibility, through the selection of suitable catalyst morphologies, of producing specific forms of secondary agglomerates, the carbon nanoparticles that can be achieved using the nanoporous catalyst particles according to the present invention are more usable and optimizable in comparison to known carbon nanoparticles with respect to their technical reprocessing.

The fibers or tubes of the thus achievable carbon nanoparticles typically have a diameter of 1-500 nm, preferably 10-100 nm, and more preferably 10-50 nm.

The size of the secondary agglomerates can be controlled through the size of the catalyst particles, the composition of the catalyst, and the selection of synthesis parameters such as the carbon source, concentrations, temperatures, and reaction time. The form of the end product is predetermined by the catalyst morphology according to the present invention. Preferably, the secondary agglomerates that can be achieved according to the invention have a diameter of 500 nm to 1000 μm. In comparison to the particle size distribution of the catalyst, the relative particle size distribution in the end product is maintained in spite of the significant volume increase.

The carbon nanofibers that can be achieved by means of the catalyst particles according to the present invention can be of the herringbone type, the platelet type, or the screw type. The carbon nanotubes can be of the single-walled or multiple-walled type or also of the loop type.

The manufacture of these carbon nanoparticles using the catalyst particles according to the present invention occurs by means of a CVD process under conditions that are known to those skilled in the art. As a carbon source, it is possible here to use carbon-containing compounds that are in gaseous form at the respective reaction temperature, e.g. methane, ethene, acetylene, CO, ethanol, methanol, synthetic gas mixtures, and biogas mixtures.

### PREFERRED EMBODIMENTS

The invention will be explained in greater detail in conjunction with the following examples and the accompanying drawings.

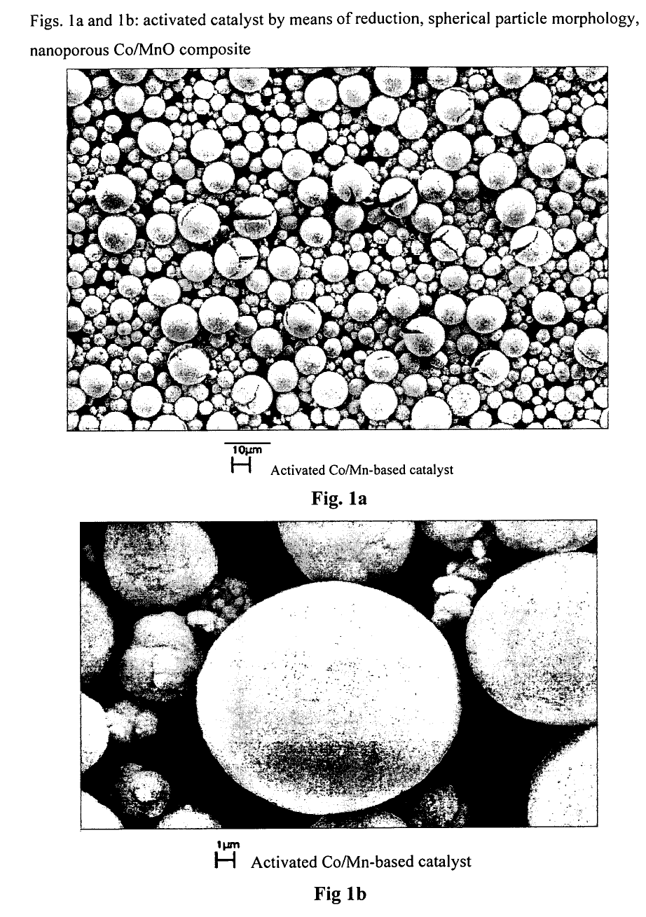

FIGS. 1a and 1b show REM images of the activated catalyst from example 1

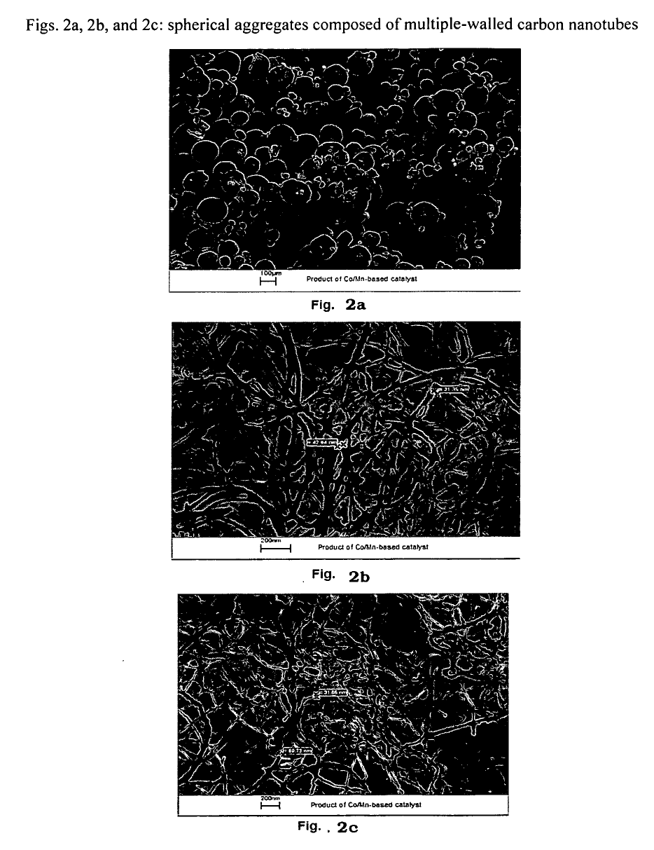

FIGS. 2a, 2b, and 2c show REM images of the product from example 1

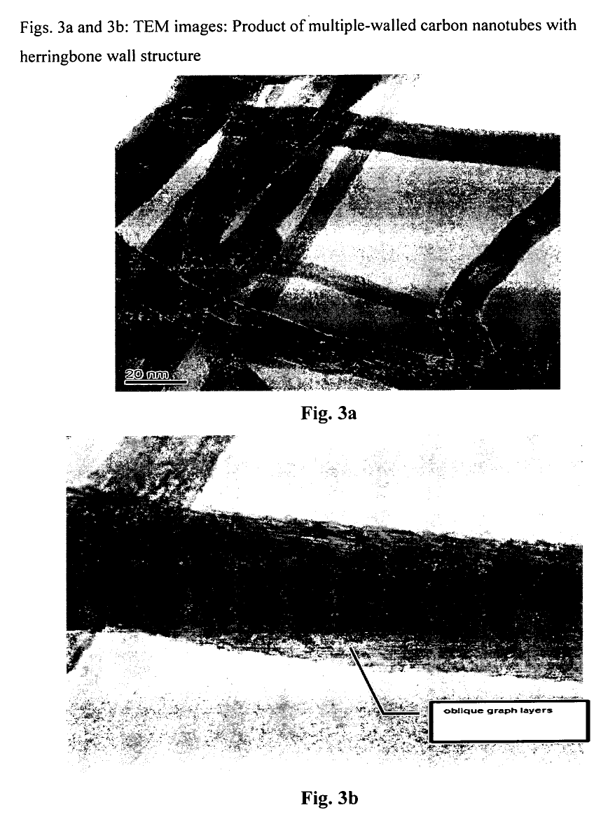

FIGS. 3a and 3b show TEM images of the product from example 1

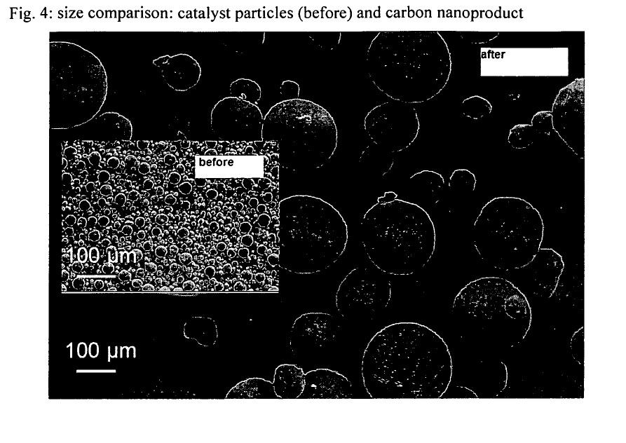

FIG. 4 shows a size comparison of the catalyst particles used and the product from example 1, based on REM images

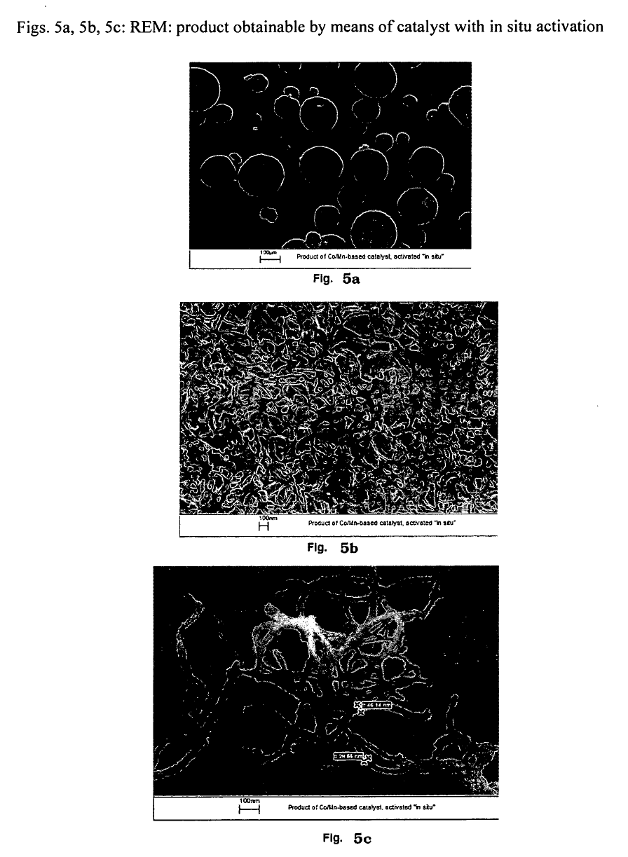

FIGS. 5a, 5b, and 5c show REM images of the product from example 2

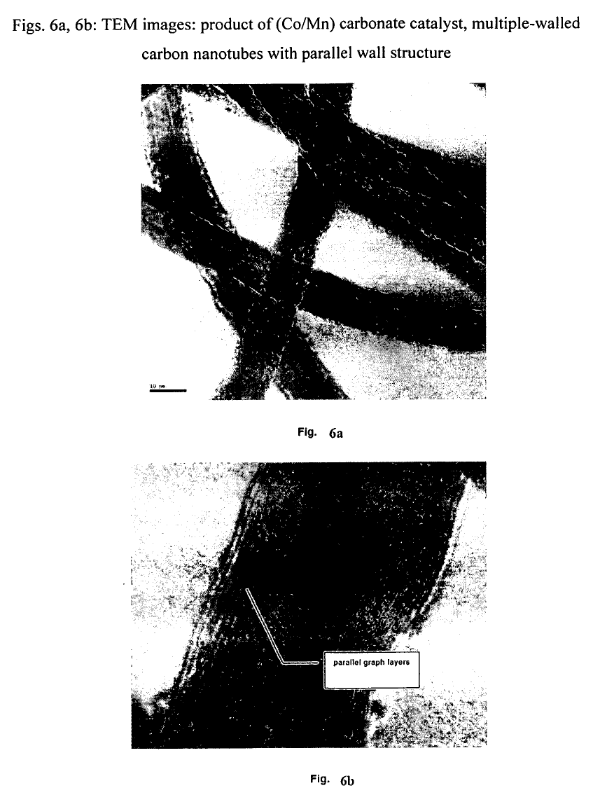

FIGS. 6a and 6b show TEM images of the product from example 2

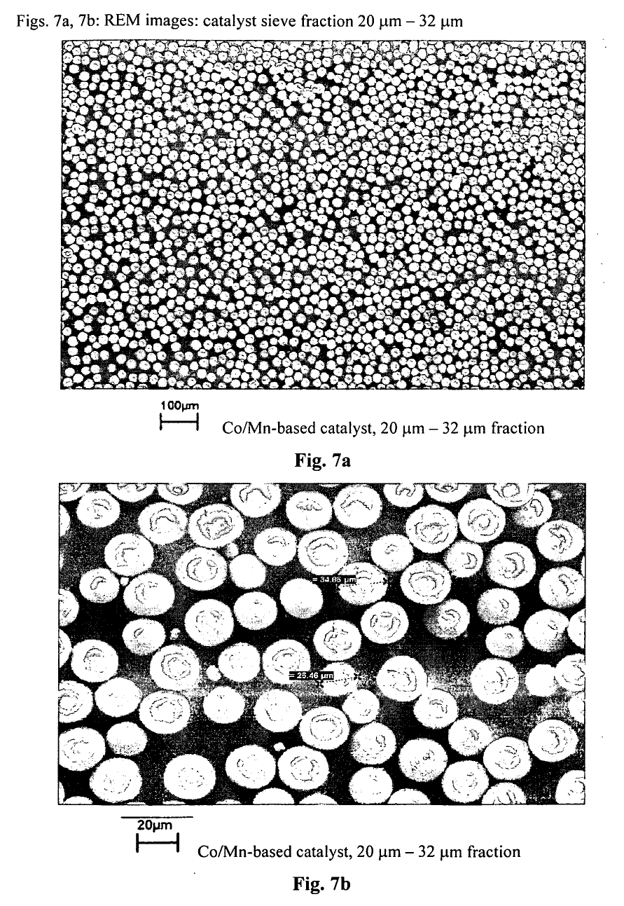

FIGS. 7a and 7b show REM images of the catalyst used in example 3

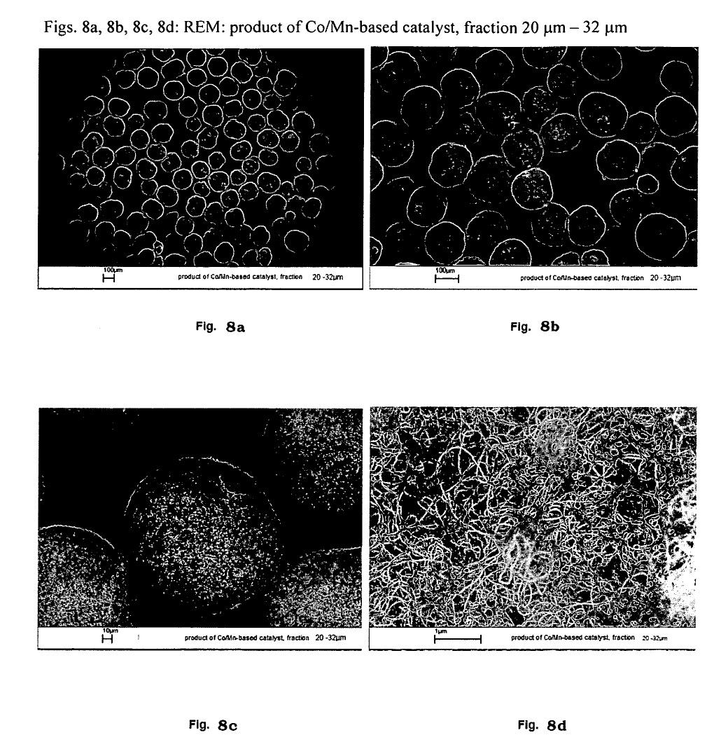

FIGS. 8a, 8b, 8c, and 8d show REM images of the product from example 3

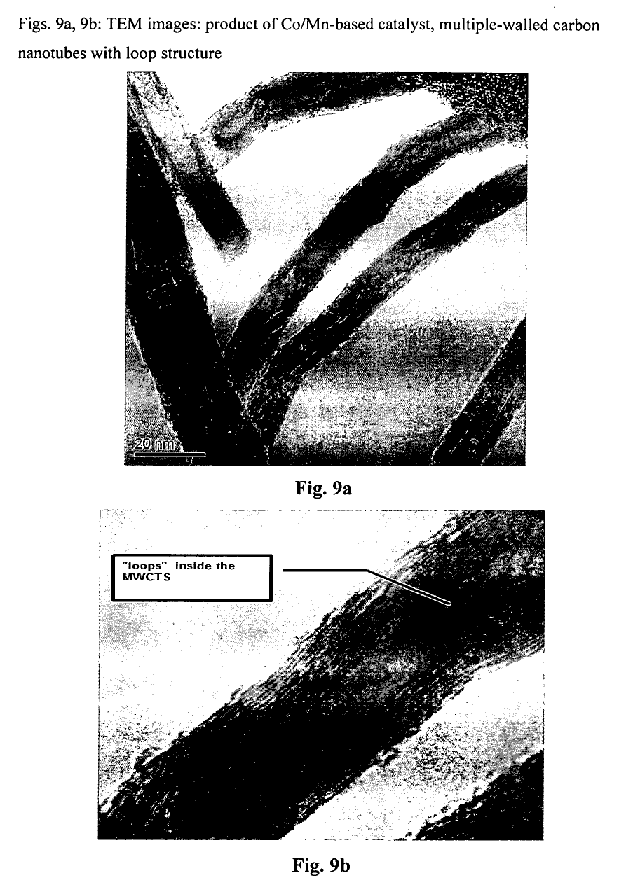

FIGS. 9a and 9b show TEM images of the product from example 3

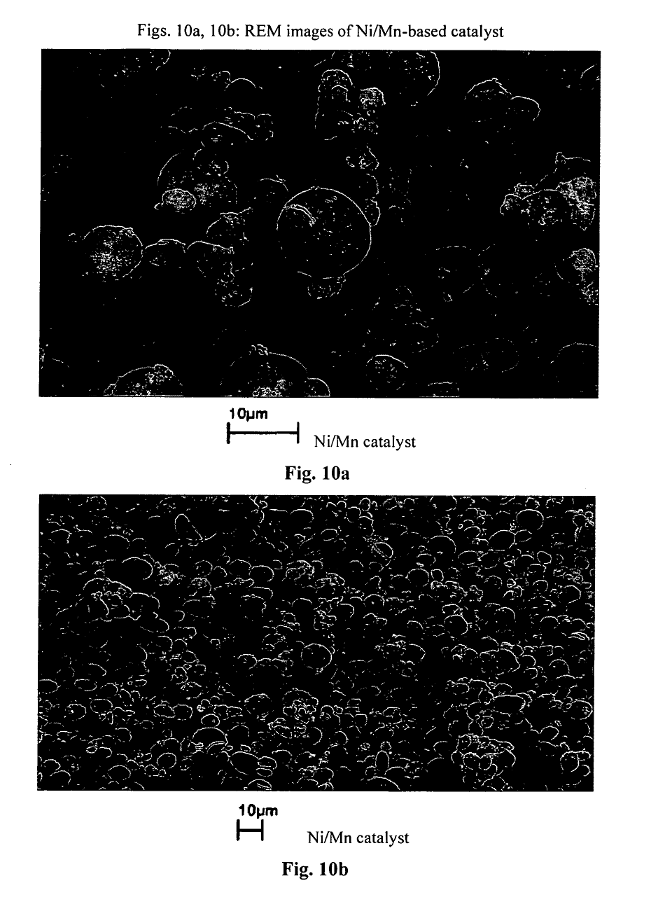

FIGS. 10a and 10b show REM images of the catalyst from example 4

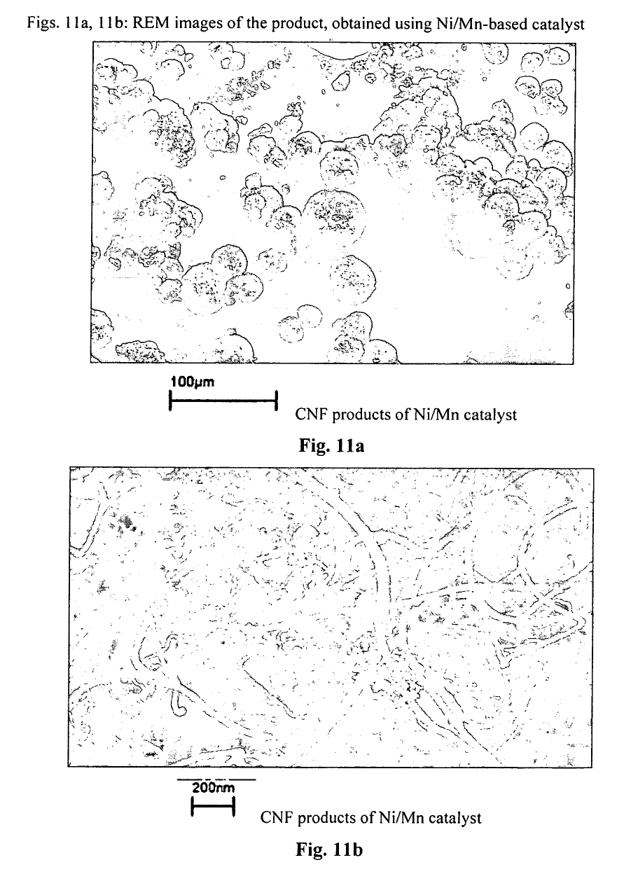

FIGS. 11a and 11b show REM images of the product from example 4

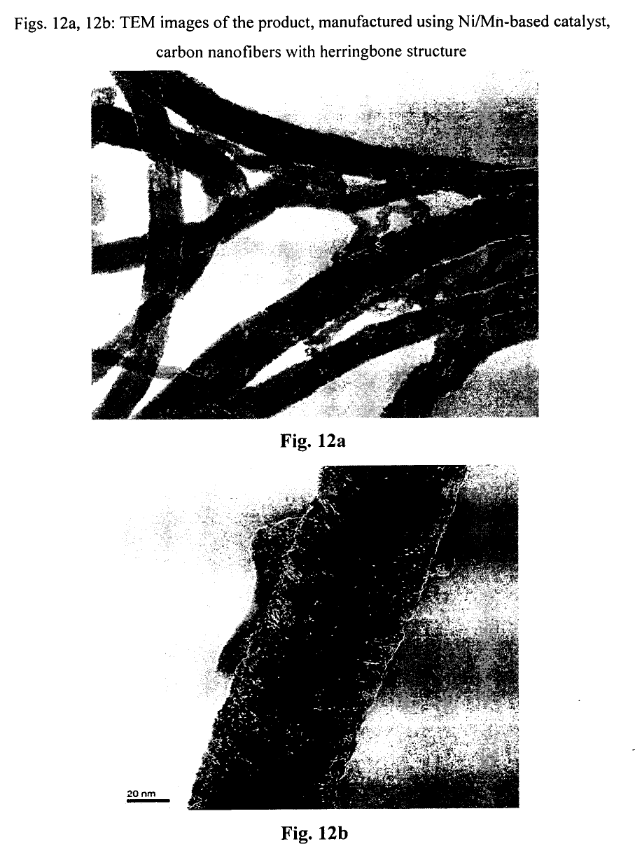

FIGS. 12a and 12b show TEM images of the product from example 4

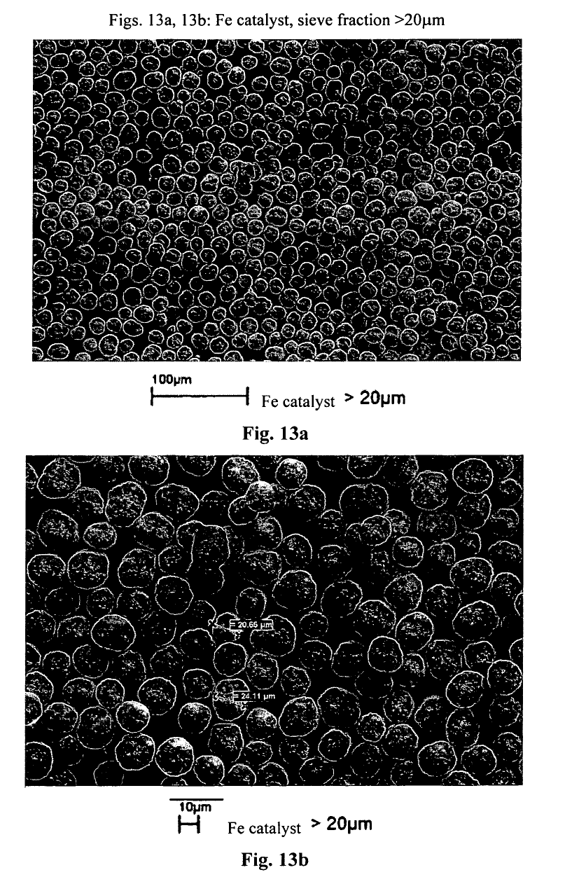

FIGS. 13a and 13b show REM images of the catalyst from example 5

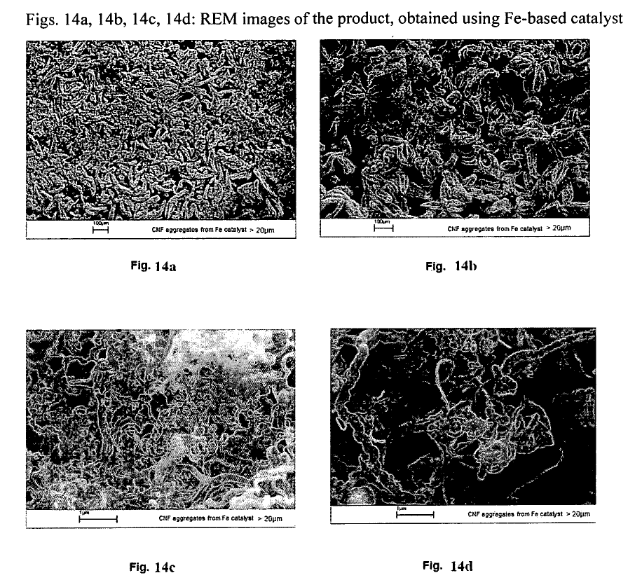

FIGS. 14a, 14b, 14c, and 14d show REM images of the product from example 5

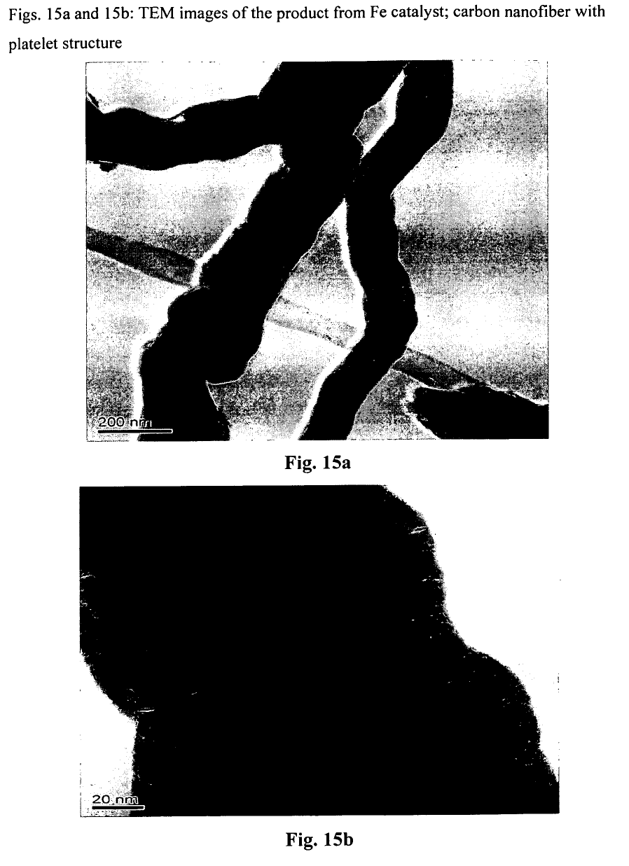

FIGS. 15a and 15b show TEM images of the product from example 5

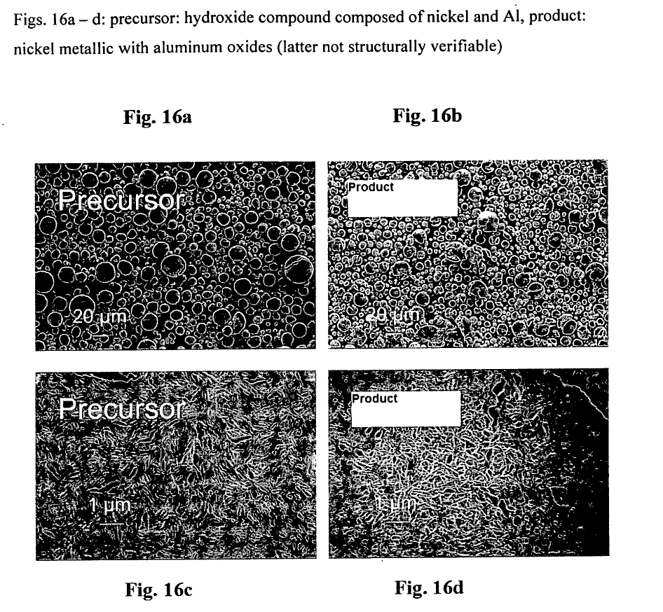

FIGS. 16a, 16b, 16c, and 16d show REM images of the catalyst from example 8

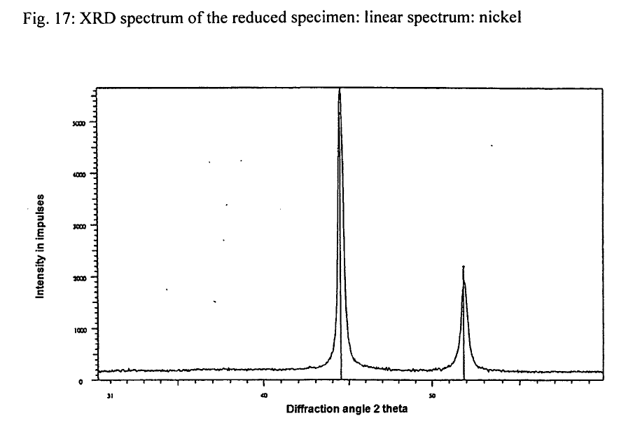

FIG. 17 shows an XRD (X-ray diffraction) spectrum of the catalyst from example 8

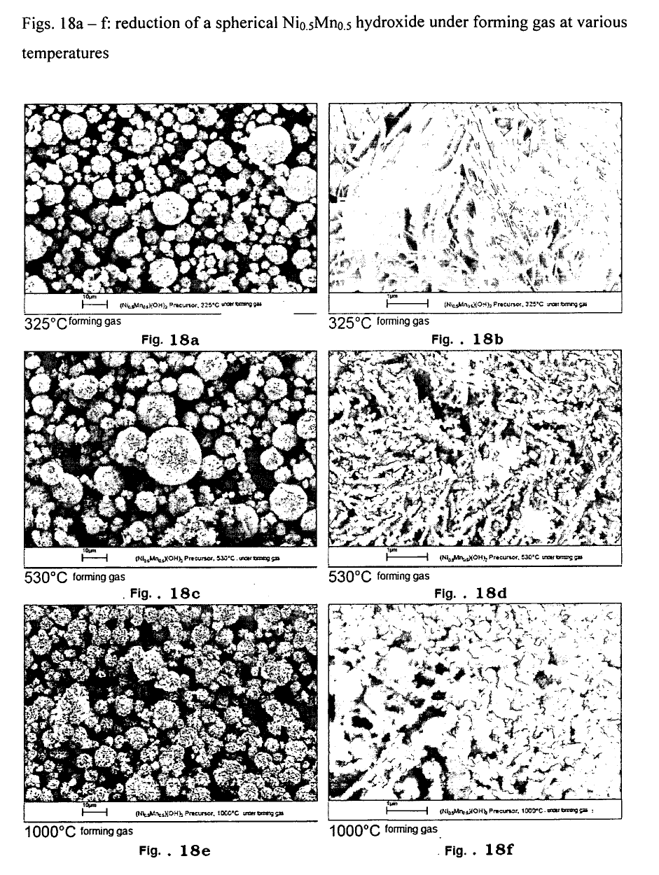

FIGS. 18a, 18b, 18c, 18d, 18e, and 18f show REM images of the catalyst from example 9 at a variety of activation temperatures

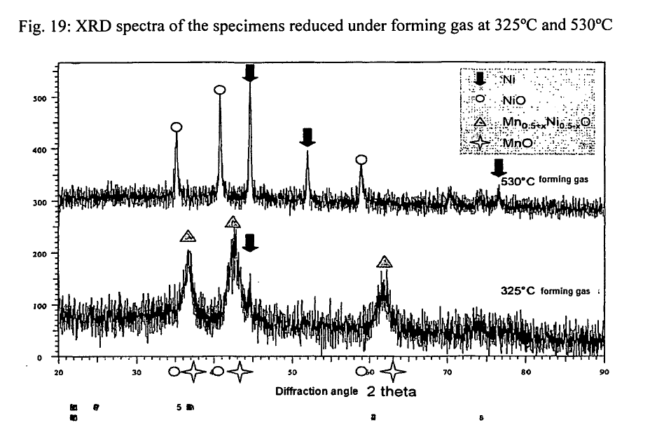

FIG. 19 shows XRD spectra of the catalyst at a variety of activation temperatures

### EXAMPLE 1

### Manufacture of a Co/Mn-Based Catalyst and its use for the Manufacture of Spherical Aggregates Composed of Multiple-Walled Carbon Nanotubes

### Manufacture of the Catalyst

The catalyst is manufactured through continuous combining of three educt solutions.

Solution I:
3050 ml of a solution of 1172.28 g (NH₄)₂CO₃ (stoichiometric) in demineralized water

Solution II:
3130 ml of a solution of 960.4 g Co(NO₃)₂*6 H₂0 and 828.3 g Mn(NO₃)₂*4 H₂O

Solution III:
960 ml of a 10.46 mole ammonia solution

The individual solutions are simultaneously metered into a 1-liter reactor at a constant metering speed over a period of 24 h; this reactor permits an intensive, thorough mixing and is equipped with an overflow via which product suspension is continuously discharged. The precipitation reaction occurs at 50° C. After the first 20 h, the discharging of the product via the overflow is begun. The suspension has a deep blue-violet color. The solid is separated from the mother liquor on a filter nutsch, then rinsed six times with 100 ml batches of demineralized water, and then dried for 30 h at 80° C. in a drying oven. This yields a powdered, easily flowing, violet precursor with spherical particle morphology.

### Activation of the Catalyst

In a corundum combustion boat, 2 g of the precursor is exposed to a forming gas flow of 5% H₂/95% N₂ for two hours at a temperature of 550° C. and transformed into a black powder that can be used as a catalyst. XRD spectra of the powder show the reflection patterns of metallic cobalt next to MnO. FIGS. 1a and 1b show REM images of the activated catalyst in the form of spherical particles.

### Manufacture of Carbon Nanoparticles

In a ceramic combustion boat, 0.2 g of the activated catalyst are placed into a tubular furnace. After a ten-minute 30 l/h flushing of the furnace with helium at a furnace temperature of 500-700° C., a mixture of ethene 10 l/h and helium 5 l/h are continuously conveyed over the specimen for a period of 5 h.

This yielded 11.2 g of a black, voluminous product.

REM images of the product are shown in FIGS. 2a, 2b, and 2c. The morphological embodiment as clearly differentiated spherical and/or spheroidal secondary structures is maintained. Highly magnified REM images show that the balls are composed entirely of fiber-shaped components (FIGS. 2b and 2c). TEM images (FIGS. 3a and 3b) verify the presence of multiple-walled carbon nanotubes.

FIG. 4 shows a size comparison between the catalyst particles used and the carbon nanoproduct obtained.

### EXAMPLE 2

### Manufacture of Multiple-Walled Carbon Nanotube Aggregates by means of a (Co,Mn)CO₃ Catalyst

A catalyst according to example 1 is used without prior activation, directly for the manufacture of multiple-walled carbon nanotubes. The transformation into multiple-walled carbon nanotubes occurs as in example 1, without a prior reduction step. The product demonstrates a uniform distribution in the thickness of the nanotubes, as is clear from the REM images in FIGS. 5a, 5b, and 5c.

The TEM images in FIGS. 6a and 6b verify the presence of multiple-walled carbon nanotubes.

### EXAMPLE 3

### Manufacture of Multiple-Walled Carbon Nanotube Aggregates with Narrow Particle Distribution by means of a (Co,Mn)CO₃ Catalyst

A catalyst according to example 1 is classed according to size by means of sieving and a particle size fraction of 20 μm-32 μm is used without prior activation, directly as a catalyst. FIGS. 7a and 7b show REM images of the catalyst sieve fraction used.

The transformation into multiple-walled carbon nanotubes takes place as in example 1.

This yields spherical aggregates composed of multiple-walled nanotubes with a narrow particle size distribution. With comparable transformation conditions, this makes it possible to adjust the size of the spherical carbon nanotube aggregates by means of the size of the catalyst particles. REM images of the product are shown at various magnifications in FIGS. 8a, 8b, 8c, and 8d.

The TEM images in FIGS. 9a and 9b confirm the presence of multiple-walled carbon nanotubes.

### EXAMPLE 4

### Manufacture of a Ni/Mn-Based Catalyst and its use for the Manufacture of Spheroidal Carbon Nanofiber Units of the “Herringbone” Type

### Manufacture of the Catalyst

Educt solutions:

Solution I:
2400 ml of a solution of 1195.8 g Mn(NO₃)₂*4 H₂O and
1385.4 g Ni(NO₃)₂*6 H₂O in demineralized water

Solution II:
7220 ml of a solution of 1361.4 g Na₂CO₃ (waterless) in demineralized water

The synthesis takes place through the continuous combining of the individual solutions as described under example 1. The reaction temperature for this catalyst is 40° C. Product discharge begins after 20 h by means of the overflow. The solid is separated from the mother liquor with a filter nutsch, then rinsed six times with 100 ml batches of demineralized water, and then dried for 30 h at 80° C. in a drying oven under protective gas. The product is powdered and light brown in color. Its color darkens when stored in the presence of air.

FIGS. 10a and 10b show REM images of the catalyst.

### Activation of the Catalyst and Synthesis of the Carbon Nanofibers of the Herringbone Type

The activation of the catalyst occurs during heating between 300° C. and 600° C. through reduction of the precursor with H₂ for approx. 20 min. (gas mixture 24 l/h C₂H₄, 6 l/h H₂).

The synthesis occurs at 500-600° C. 2 h with a mixture of 32 l/h C₂H₄, 8 l/h H₂.

FIGS. 11a and 11b show REM images of the product. The morphological embodiment in the form of clearly differentiated spherical and/or spheroidal secondary structures is maintained.

The TEM images in FIGS. 12a and 12b confirm the presence of carbon nanofibers with a herringbone structure.

### EXAMPLE 5

### Manufacture of an Fe-Based Catalyst and its use for the Manufacture of Flower-Like Carbon Nanofiber Units of the “Platelet” Type

### Manufacture of the Catalyst

Solution I:
3000 ml of a solution of 1084.28 g Fe(II)SO₄*7 H₂O in demineralized water

Solution II:
6264 ml of a solution of 426.3 g (NH₄)₂CO₃ (stoichiometric) in demineralized water.

The synthesis takes place through the continuous combining of the individual solutions as described under example 1; the reaction temperature for this catalyst is 45° C. Product discharge begins after 20 h by means of the overflow. The solid is separated from the mother liquor on a filter nutsch, then rinsed six times with 100 ml batches of demineralized water, and then dried for 30 h at 80° C. in a drying oven. All steps are carried out under nitrogen. The product is powdered and light brown in color. Its color darkens when stored in the presence of air.

FIGS. 13a and 13b show REM images of the catalyst sieve fraction >20 μm.

### Activation of the Catalyst and Synthesis of Platelet Carbon Nanofibers

In a corundum combustion boat, 2 g of the precursor is activated in a helium/hydrogen mixture (2/3:1/3) for two hours at a temperature of 380° C.

The synthesis of the carbon nanofibers occurs under a carbon monoxide/hydrogen flow (20:8) for a period of four hours. This yields a black, voluminous product.

REM images of the product are shown at various magnifications in FIGS. 14a, 14b, 14c, and 14d. Clearly differentiated secondary agglomerates in the form of flower-like units are produced, whose outer circumference is spheroidal.

The TEM images in FIGS. 15a and 15b confirm the presence of carbon nanotubes of the platelet type.

### EXAMPLE 6

### Manufacture of a Spherical Co/Ni/MnO Composite Catalyst

The catalyst is manufactured through continuous combining of three educt solutions in a fashion analogous to example 1.

Solution I:
2400 ml of a solution of 604.2 g him Co(NO₃)₂*6 H₂O,
589.1 g Ni(NO₃)₂*6 H₂O, and
497.6 g Mn(NO₃)₂*4 H₂O in demineralized water

Solution II:
2400 ml of a solution of 481.5 g NaOH in demineralized water.

Solution III:
6159 g of a 2.58% ammonia solution (1.49 M)

Subsequent reduction to a Ni/Co/MnO composite at between 300° C. and 1000° C. in forming gas.

### EXAMPLE 7

### Manufacture of a Co/Ni/Mg-Based Catalyst

The catalyst is manufactured through continuous combining of three educt solutions in a fashion analogous to example 1.

Solution I:
1920 ml of a solution of 425.0 g Co(NO₃)₂*6 H₂O,
424.6 g Ni(NO₃)₂*6 H₂O, and
499.2 g Mg(NO₃)₂*6 H₂O in demineralized water

Solution II:
1920 ml of a solution of 385.2 g NaOH in demineralized water.

Solution III:
4927 g of a 2.58% ammonia solution (1.49 M)

Subsequent reduction to a Ni/Co/MgO composite at between 300° C. and 1000° C. in forming gas.

### EXAMPLE 8

### Manufacture of a Ni/Al-Based Catalyst

The manufacture of spherical hydroxide-based precursors on the basis of nickel and aluminum occurs in a fashion analogous to examples 6 and 7 through the use of equivalent molar total quantities of soluble Ni(II) salts and Al(III) salts in solution I.

The precursors are reductively thermolyzed under forming gas. The existing product was reduced at 1000° C.

FIGS. 16a, 16b, and 16c show REM images of the catalyst precursor while 16d shows an REM image of the activated catalyst (product).

As is clear from FIGS. 18a-d, not only is the spherical particle form of the precursor maintained, but also the platelet shape of the particles of which the grain is constructed. The precursor gives the product its external form and internal architecture. In the present instance, the spherical products are composed of platelet-like nickel metal (see XRD, FIG. 17) (thickness=100 nm) with a high internal pore component as a composite with aluminum oxides. The latter cannot be structurally verified in the present specimen.

### EXAMPLE 9

### Manufacture of a Ni/MnO Catalyst Based on Hydroxide Precursors

The manufacture of spherical hydroxide-based precursors on the basis of nickel and manganese occurs in a fashion analogous to examples 6 and 7 through the use of equivalent molar total quantities of soluble Ni(II) salts and Mn(III) salts in solution I. The precursors are then reductively thermolyzed under forming gas.

The existing products demonstrate that the properties can be selectively adjusted by means of the reduction conditions.

In the REM of the specimen reduced at 325° C., the spherical particle form and primary crystallite are unchanged. The XRD spectrum, however, shows that small quantities of elementary nickel have already formed under these conditions (nickel: black arrow in FIG. 19). The remaining reflections (gray triangle) indicate a powerfully interrupted crystal grid of the manganosite (MnO) type or nickel oxide NiO type; the reflection positions are situated between those of the pure compounds MnO (star) and NiO (circle).

In the XRD spectrum, the reduction at 530° C. shows a sharp rise in the intensity of the nickel reflections, while the position of the MnO reflections shifts toward that of the manganosite MnO. In this specimen as well, the REM images show no changes to the spherical morphology. The platelet-like form of the primary crystallite is maintained and consequently, so is the pore structure predetermined by the precursor. However, these platelet-like primary particles are now filled with small ball-like particles with sizes between 50 nm and 100 nm. The particle is composed of a nanoporous Ni/MnO composite.

Significant particle growth is visible in the specimen reduced at 1000° C. Here, too, the particle form is maintained and a shrinkage is observed. The particles are not densely sintered. Particularly in the overview image, it is clear that here, too, the internal architecture (“platelet-like”) has been more or less maintained.

These spherical and spheroidal powders can be adjusted in form and structure by means of the precursor synthesis. The growth structure of the particle is so stable that it can also be maintained over a wide temperature range in the conversion into a metal/metal oxide composite, thus allowing the internal porosity of the particles (form and size distribution of the pores) to be adjusted as needed by means of the synthesis conditions.

The formation of the nanounits of the composite can be controlled through the selection of the element combinations and their ratios in the product, the reaction temperature, the reaction atmosphere, and the reaction time.

1. Nanoporous catalyst particles with a spherical and/or spheroidal secondary structure, which contain, as catalytically active components, transition metals and/or their oxides or their precursors.

2. The nanoporous catalyst particles as recited in claim 1, wherein the transitional metals are selected from among Fe, Co, Ni, and Mn.

3. The nanoporous catalyst particles as recited in claim 1, wherein the precursors are poorly soluble compounds such as hydroxides and carbonates.

4. The nanoporous catalyst particles as recited in claim 1, wherein the catalytically active components are deposited onto a support material.

5. The nanoporous catalyst particles as recited in claim 1, wherein the spherical and/or spheroidal secondary structures have a diameter of 0.5-100 □m.

6. A method for manufacturing nanoporous catalyst particles as recited in claim 1, in which, by means of a precipitation process, precursors with a spherical and/or spheroidal preliminary shape are produced from soluble combinations of the active components and in a thermal activation step, these morphologically pre-shaped precursors are transformed into the nanoporous catalyst particles with a spherical and/or spheroidal secondary structure.

7. The nanoporous catalyst particles as recited in claim 6, wherein the activation step is carried out in an oxidative or reductive atmosphere.

8. The method as recited in claim 6, wherein the activation step is carried out at temperatures in the range from 300 to 1000° C.

9. The method as recited in claim 6, wherein the activation step is carried out ex situ or in situ during the technical use of the catalyst particles.

10. A use of the nanoporous catalyst particles as recited in claim 1 in the manufacture of ceramic materials.

11. A use of the nanoporous catalyst particles recited in claim 1 as electrode materials, in electrochemical cells, or in fuel cells.

12. A use of the nanoporous catalyst particles recited in claim 1 as storage materials for chemical species.

13. A use of the nanoporous catalyst particles as recited in claim 1 in the manufacture of carbon nanoparticles in the form of tubes or fibers.
